(19) United States
(12) Patent Application Publication
(10) Pub. No.: US 2017/0172706 A1
(43) Pub. Date: Jun. 22, 2017

(54) DENTAL POST DESIGNED FOR IMPROVED CROWN BONDING AND REDUCED ROOT DAMAGE

(71) Applicant: ARCHER MEDICAL, LLC, Colts Neck, NJ (US)

(72) Inventors: THOMAS E. LAPINSKI, Sussex, NJ (US); Arthur A. Alfaro, Colts Neck, NJ (US)

(21) Appl. No.: 15/446,288

(22) Filed: Mar. 1, 2017

Related U.S. Application Data
(63) Continuation-in-part of application No. 15/355,503, filed on Nov. 18, 2016.
(60) Provisional application No. 62/257,576, filed on Nov. 19, 2015.

(51) Int. Cl. A61C 5/35; A61C 13/30

(52) U.S. Cl. CPC A61C 5/35; A61C 13/30

(57) ABSTRACT

A post for a dental crown is disclosed having improved structural features—including increased post strength and reduced likelihood of root fracture. In one embodiment, the post includes a quadrangle (4-way) split shank for increased compliance and root stress reduction while providing very high mechanical grip strength and pull-out resistance. In another embodiment, a shortened threaded section and a thread-free shank tip minimize the possibility of root fracture while still providing high grip strength and pull-out resistance. Embodiments also include a radiused transition from a primary thread to a secondary thread portion of the shank for stress reduction; and axial grooves, cross-axis through holes and other shape features of the post head for increased crown retention strength.

### CROSS-REFERENCE TO RELATED APPLICATIONS

This is a Continuation-in-Part application claiming priority to U.S. Utility patent application Ser. No. 15,355,503, titled, DENTAL POST DESIGNED FOR INCREASED STRENGTH AND REDUCED ROOT DAMAGE, filed Nov. 18, 2016, which claims the benefit of the priority date of U.S. Provisional Patent Application Ser. No. 62/257,576, titled, DENTAL POST DESIGNED FOR INCREASED STRENGTH AND REDUCED ROOT DAMAGE, filed Nov. 19, 2015.

### BACKGROUND OF THE INVENTION

Field of the Invention

This invention relates generally to a dental post used to anchor a crown and, more particularly, to a dental post including a quadrangle split shank for increased compliance and root stress reduction, a thread-free shank tip option to eliminate the possibility of root fracture, a radiused transition from a primary thread to a secondary thread for stress reduction, and an axially grooved post head with through holes for increased crown retention.

Description of the Related Art

A dental crown is a tooth-shaped cap that is placed over a tooth to cover the tooth to restore its shape and size, strength, and improve its appearance. The crown, when cemented into place on a post, fully encases the entire visible portion of a tooth that lies at and above the gum line. The crown is mounted to a post which extends deep down into the root canal of the tooth in order to provide strength and stability.

A crown post must provide a strong mounting to the tooth and root—including the ability to withstand lateral forces and bending moments, and resistance to pull-out. Post designs are known in the art which thread down into the root canal to provide the grip and mounting strength required for a solid crown mount. However, these threaded designs may put excessive stress on the tooth and root, and these stresses can cause a root to fracture—resulting in more extensive dental repair work. Other prior art posts do not thread into the root, but rather are simply cemented in place. These thread-free designs minimize the risk of root fracture, but suffer from very limited pull-out strength due to the absence of any mechanical grip.

A crown is needed which provides high pull-out resistance while minimizing the risk of root fracture, and incorporates other features for increased post strength and increased post-to-crown retention.

### SUMMARY OF THE INVENTION

In accordance with the teachings of the present invention, a post for a dental crown is disclosed having improved structural features—including increased post strength and reduced likelihood of root fracture. In one embodiment, the post includes a quadrangle (4-way) split shank for increased compliance and root stress reduction while providing very high mechanical grip strength and pull-out resistance. In another embodiment, a shortened threaded section and a thread-free shank tip minimize the possibility of root fracture while still providing high grip strength and pull-out resistance. Embodiments also include a radiused transition from a primary thread to a secondary thread portion of the shank for stress reduction, and an axially grooved post head with cross-axis through holes for increased crown retention strength.

Additional features of the present invention will become apparent from the following description and appended claims, taken in conjunction with the accompanying drawings.

### BRIEF DESCRIPTION OF THE DRAWINGS

FIG. 1 is a side view illustration of a prior art crown post;

FIG. 2 is an isometric view illustration of the prior art crown post of FIG. 1;

FIG. 3 is an illustration of a crown post with a 4-way split shank and other features, according to an embodiment of the invention;

FIG. 4 is an end view illustration of the crown post of FIG. 3, showing the 4-way split shank designed to create less stress in the tooth and root;

FIGS. 5 A/B are cross-sectional views of the shank portion of the prior art post of FIG. 1 and the 4-way split shank of the post of FIG. 3, illustrating the effect of the shank design on radial compliance;

FIG. 6 is a side view illustration of a crown post with a hybrid shank including an unthreaded tip and a shorter primary thread, according to an embodiment of the invention;

FIG. 7 is an oblique side view illustration of a crown post with a hybrid shank as in FIG. 6, but including a different type of post head;

FIG. 8 is an oblique end view illustration of a crown post with the same type of head as in FIG. 7, but with the split shank of FIG. 3, and also showing an internal drive socket head, according to an embodiment of the invention;

FIG. 9 is a side view illustration of a crown post with a combination of features discussed above and a different type of external thread, according to an embodiment of the invention;

FIG. 10 is a cross-sectional illustration of a buttress thread, as used for the primary thread on the post of FIG. 9;

FIG. 11 is an end view illustration of the crown post of FIG. 9; and

FIG. 12 is an illustration of a crown post, similar to the post of FIG. 9, with cross-axis through-holes added for improved cement distribution and crown holding strength.

### DETAILED DESCRIPTION OF THE EMBODIMENTS

The following discussion of the embodiments of the invention directed to a dental crown post with improved structural features is merely exemplary in nature, and is in no way intended to limit the invention or its applications or uses.

A dental crown is a tooth-shaped cap that is placed over a tooth to cover the tooth to restore its shape and size, strength, and improve its appearance. The crown is mounted to a post which extends deep down into the root canal of the tooth in order to provide strength and stability. The crown post must be securely mounted to the tooth and root—providing the ability to withstand lateral forces and bending moments, and resistance to pull-out.

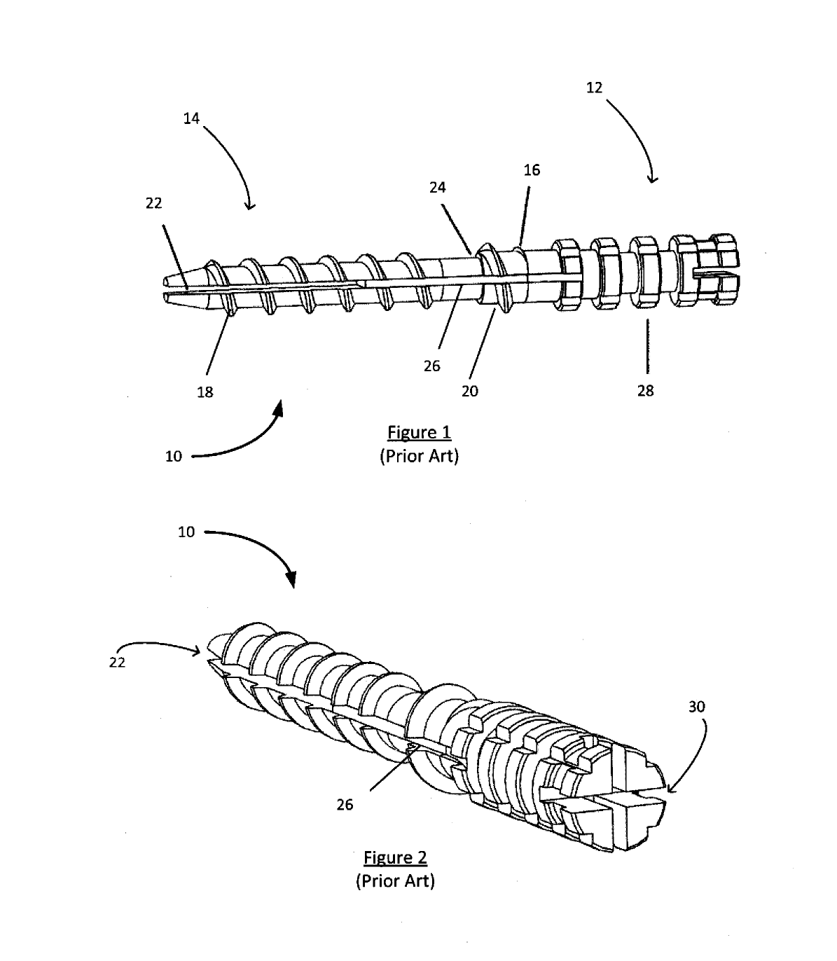

FIG. 1 is a side view illustration and FIG. 2 is an isometric view illustration of a crown post 10 of a type known in the art which threads down into the root canal to provide the grip and mounting strength required for a solid crown mount. The post 10 includes a head 12, sometimes referred to as the coronal end, which is the portion which protrudes out of the tooth and to which the crown is attached. The post 10 also includes a shank 14, or apical end, which is the portion which is anchored into the tooth and root to securely fix the post. To further explain the configuration of the post 10, the head 12 is “above” a gum line 16 (exposed), and the shank 14 is below the gum line 16 (buried) when the post 10 is anchored in place.

The post 10 includes a primary thread 18 which runs along the length of the shank 14, and a secondary thread 20—typically only a single turn—located near the gum line 16. The primary thread 18 cuts into the tooth and root as the post 10 is threaded into position, while the secondary thread 20 threads into the tooth. The primary thread 18 and the secondary thread 20 provide a secure attachment of the post 10 to the tooth and root due to the significant mechanical grip of the threads. However, the threaded design of the post 10 may put excessive stress on the tooth and root, and these stresses can cause a root to fracture—resulting in more extensive dental repair work. The shank 14 of the post 10 includes a slot 22—running axially through the shank 14—intended to reduce stress in the tooth and root by allowing compliance of the shank 14. However, in actual usage, the shank 14 of the post 10 offers only limited compliance and causes root fracture in a significant number of cases. This will be discussed further below.

The post 10 includes a transition 24 from the shank to a middle section containing the secondary thread 20. The transition 24 is typically a step function change of diameter which acts as a stress concentration and has been known to cause post breakage. The post 10 also includes a vent groove 26 which is intended to allow cement to extrude up out of the root hole during installation of the post 10. In practice however, the vent groove 26 also causes a stress concentration in the middle section of the post 10, where torque is highest during installation, resulting in even more post failures.

Finally, the post 10 includes rings 28 along the length of the head 12, and drive slots 30 in the top of the head 12. The rings 28 provide mechanical retention of the crown to the post 10, while the drive slots 30 are designed to receive a screwdriver-like tool which is used to install the post 10 in the patient. The post 10, having threads which engage the tooth and root, is sometimes known as an active post design.

Other prior art posts do not thread into the root, but rather have an unthreaded shank portion which is simply cemented in place. These thread-free designs—sometimes known as passive post designs—minimize the risk of root fracture, but suffer from very limited pull-out strength due to the absence of any mechanical grip. A new type of crown post is needed which overcomes the limitations of the post 10 and other known post designs.

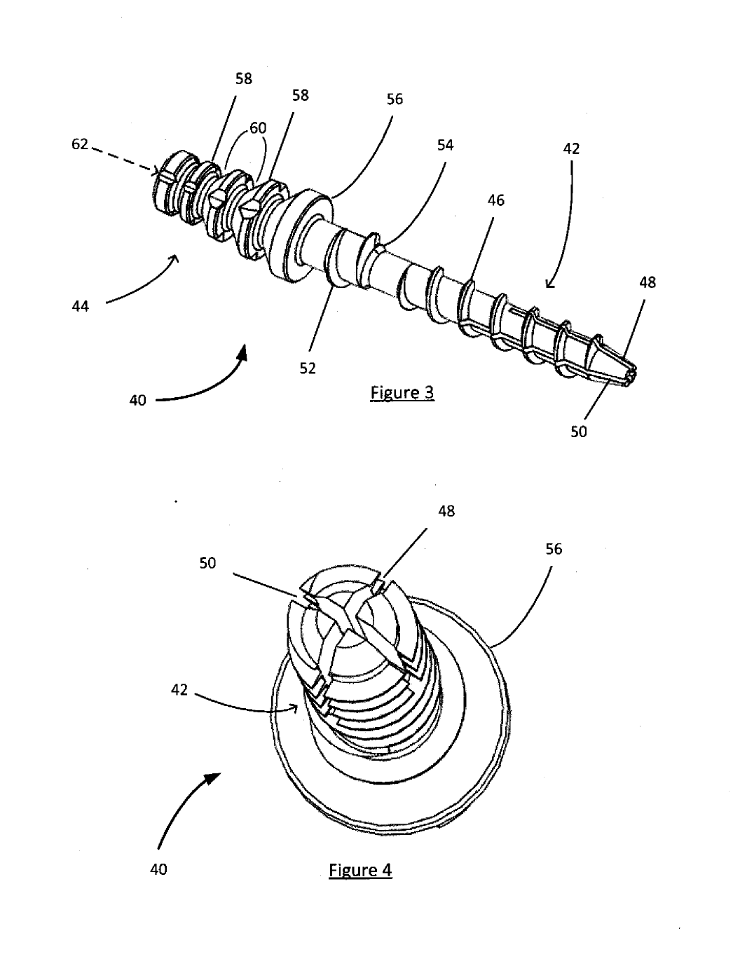

FIG. 3 is an illustration of a crown post 40 with a 4-way split shank and other features for increased strength and reduced root damage, according to an embodiment of the invention. The post 40 includes a shank 42 (apical end) and a head 44 (coronal end). The shank 42 includes a primary thread 46 extending along the length of the shank 42, and two longitudinal slots 48 and 50. The slots 48 and 50, which split the shank 42 into four segments, provide much greater radial compliance in the shank 42 than exhibited by the prior art post 10, as will be illustrated and discussed further below. Note that the slots 48 and 50 may be of equal length, or they may have different lengths (that is, the slot 48 may extend a different distance along the length of the shank 42 than does the slot 50—as illustrated in FIG. 3).

The post 40 also includes a secondary thread 52 at the top of the shank 42 and just below the head 44, and a radiused transition 54. The radiused transition 54 eliminates the step-function change in diameter of the post 40, thereby reducing the stress concentration and resulting in a stronger post. The primary thread 46 and the secondary thread 52 are preferably orthopedic threads designed specifically for efficiently cutting into organic structures such as bone, tooth or root.

The post 40 further includes a flange 56 at the base of the head 44. The flange 56 is substantially wider (greater diameter) than the rest of the post 40, thereby providing better contact with the base of the tooth into which it is implanted, resulting in greater strength and stability of the post 40. The wide flange 56 is a feature not seen on prior art posts such as the post 10. Above the flange 56, continuing toward the top of the post 40, is a series of alternating circumferential rings 58 and grooves 60. The rings 58 and grooves 60 provide the head 44 with a shape which allows for a solid mechanical grip of the crown when cemented onto the post 40. Proceeding from the flange 56 toward the top of the head 44, each of the rings 58 has a slightly smaller diameter, giving the head 44 a tapered “Christmas tree” shape. The tapered shape of the head 44 on the post 40 provides dentists with a post option including a wide base which is suitable for some situations. Other embodiments—discussed below—include a head shape which is not tapered.

Also visible in FIG. 3 is a notch 62 which is cut through the rings 58 in the head 44. Although difficult to see in a single illustration, the post 40 actually includes four of the notches 62, equally circumferentially spaced around the rings 58. The notches 62 provide additional mechanical grip of the crown onto the head 44 of the post 40—specifically preventing rotation of the crown about the axis of the post 40. The notches 62 on the post 40 are shown with a V-shape cross-section, but other suitable notch shapes may be used. Furthermore, more or fewer than four of the notches 62 may be used in some embodiments.

FIG. 4 is an oblique end view illustration of the crown post 40 of FIG. 3, clearly showing the 4-way split shank 42 which results from the slots 48 and 50. In a preferred embodiment, the slots 48 and 50 are at right angles to each other in the end view, and are each centered on the cross-section, thereby resulting in four equal longitudinal segments of the shank 42. As mentioned earlier and shown in FIG. 3, the slots 48 and 50 may have different lengths. The flange 56 is visible in FIG. 4, and blocks visibility of the head 44.

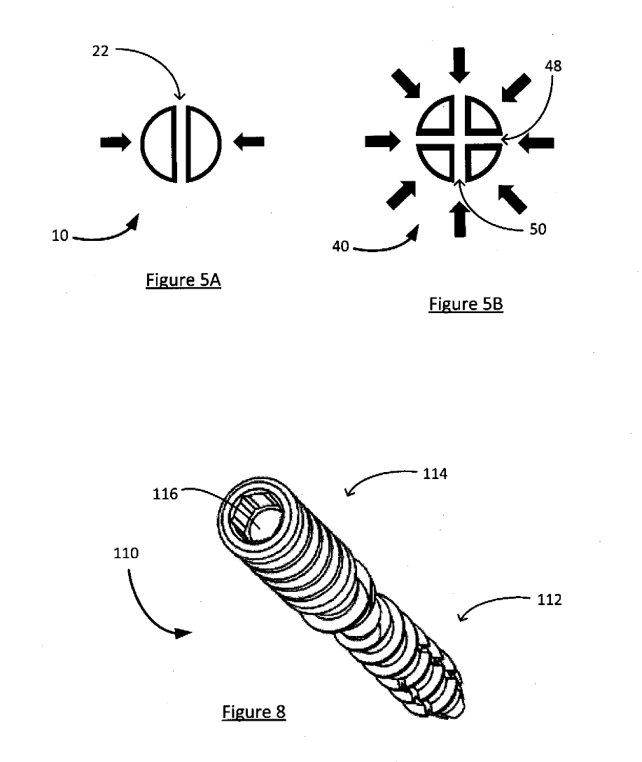

FIGS. 5 A/B are cross-sectional apical views of the shank portion of the prior art post 10 of FIG. 1 and the 4-way split shank of the post 40 of FIG. 3. In FIG. 5A, it can be seen that the single slot 22 offers only limited radial compliance in the shank, and the compliance that does exist is limited to the direction perpendicular to the slot 22—as shown by the two solid arrows. It is apparent that the shank is essentially rigid in compression in the direction parallel to the slot 22 (up and down in FIG. 5A). This shank rigidity causes extremely high radial compressive stress and circumferential tensile (“hoop”) stress in the root, and is known to cause root fracture in some patients when the prior art post 10 is installed.

In order to avoid root fracture and its undesirable consequences, the post 40 is designed to offer compliance in all radial directions during installation. The 360° radial compliance is due to the slots 48 and 50, which not only offer compliance in the directions perpendicular to the slots 48 and 50 (up/down/left/right directions in FIG. 5B), but also in the diagonal directions. The compliance in the diagonal directions is due to the fact that the segments of the 4-way split shank 42 have a small enough bending cross-section that they will bend, and they have room to move because of the two perpendicular slots 48 and 50. The much greater compliance of the 4-way split shank 42 as compared to the prior art shank 14 results in dramatically reduced stresses in the root during installation of the post 40, while still providing positive thread engagement and post stability.

The post 40 discussed above offers a number of structural features which reduce the likelihood of root fracture due to post installation, and also increase the strength of the post itself. Other post features—illustrated and described below—may be used in combination with or replacement of certain features of the post 40, thus providing dentists with the flexibility to best meet the needs of any individual patient.

FIG. 6 is a side view illustration of a crown post 70 with a hybrid shank, according to an embodiment of the invention. The post 70 includes a shank 72 and a head 74, according the convention discussed previously. The shank 72 is a hybrid design including an unthreaded tip 76 and a shorter primary thread 78. In some crown patients, the lower portion of the root canal is too fragile to withstand threading-in of a post shank. In such patients, a hole can be drilled to accept the unthreaded tip 76, thus eliminating radial and hoop stresses on the root associated with threading in a post shank. The unthreaded tip 76 then fits down in the post hole in the lower root canal upon post installation, where it provides lateral stability of the post 70. The tip 76 also offers some pull-out resistance by virtue of the cement used during installation. Ring grooves along the length of the unthreaded tip 76 provide visual reference for trimming the tip 76 to length before installing the post, and also offer a grip feature for improved cement adhesion.

Studies have shown that the top three threads of a threaded fastener provide almost all of the axial pull-out resistance. The post 70 therefore includes three full turns of the primary thread 78, which along with a secondary thread 80, anchor the post 70 securely. In one embodiment, the shank 72 is approximately equally divided between the unthreaded tip 76 and the section containing the primary thread 78.

The head 74 of the post 70 is of the same design as the head 44 of the post 40, with a flange and a tapered “Christmas tree” shape of rings. The head 74 includes a slot 82—visible in FIG. 6—which accepts a screwdriver-type tool to provide the torque needed for installation of the post 70. Two sets of anti-rotation notches 84—the same as the notches 62 discussed previously—are also visible in FIG. 6.

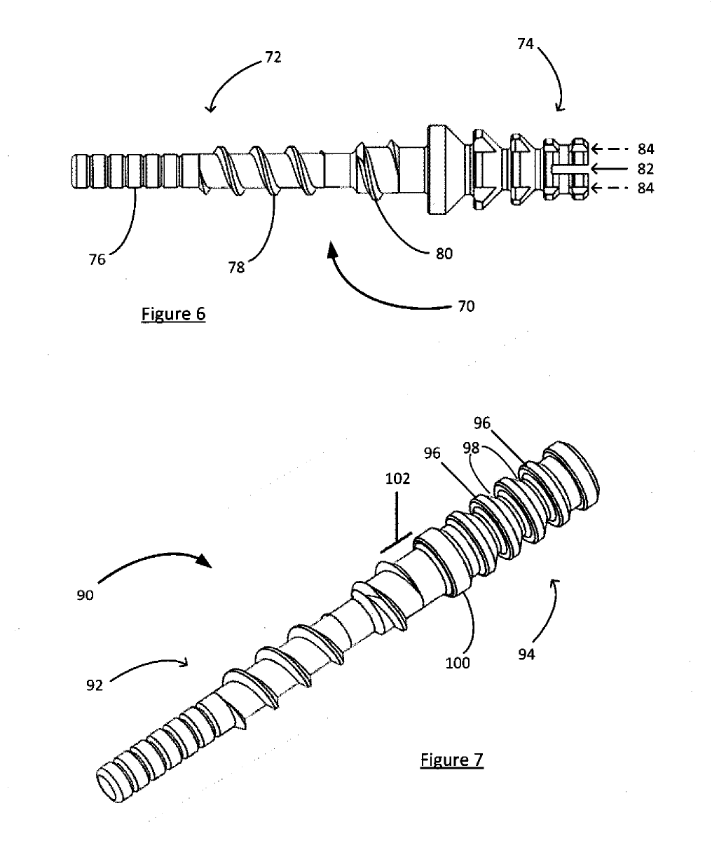

FIG. 7 is an oblique side view illustration of a crown post 90 with a hybrid shank design as in the post 70 of FIG. 6, but with a different head style. The post 90 includes a hybrid shank 92, with an unthreaded tip and a shorter primary thread as discussed for the shank 72 of the post 70. The post 90 includes a head 94 which is different than the post heads discussed previously. The head 94 has a straight-sided design, rather than a tapered or “Christmas-tree” shape as in embodiments described above. The head 94 includes a plurality of alternating rings 96 and grooves 98 for crown retention, but unlike in the heads 44 and 74, the rings 96 all have the same outer diameter. The head 94 also includes bottom band 100 which is the same diameter as the rings 96. The straight-sided head 94 may be most suitable in teeth which cannot accommodate the extra width of the wide flange 56.

The post 90 also includes a region 102—just below the head 94 and above the secondary thread—where material properties may be locally improved through shot peening, cold forging or other processes. The region 102 is an area known to be susceptible to failure in prior art post designs. Localized material treatments—particularly in metal materials—can both increase material strength and reduce surface imperfections to minimize post failure in this area.

Although the post 90 of FIG. 7 does not show any notches in the rings 96—similar to the notches 62 of the post 40—such notches may be included in the head 94 of the post 90. As discussed previously, these notches provide additional mechanical grip of the crown onto the head—specifically preventing rotation of the crown about the axis of the post. Four sets of these notches, equally circumferentially spaced around the rings 96 is a preferred design, although other numbers of notches are envisioned.

FIG. 8 is an oblique end view illustration of a crown post 110, according to another embodiment of the invention. The post 110 includes a different combination of head style and shank style than seen in previous figures. Specifically, the post 110 includes a shank 112 of the 4-way split shank design seen previously in the post 40 of FIGS. 3 and 4. However, rather than a tapered head style as in the post 40, the post 110 includes a straight-sided head 114 as in the post 90 of FIG. 7. The post 110 also includes an internal drive socket 116 in the head 114, where the internal drive socket 116 accepts an Allen-wrench-type tool to provide the torque needed for installation of the post 110. The internal drive socket 116 may be preferable to the straight slot 82 in some instances—for example, to prevent the tool from slipping out of position during post installation. The straight-sided head 114 would preferably include the crown anti-rotation notches, not shown in FIG. 8.

Looking back at the posts 40/70/90/110 of the preceding figures, it can be seen that there are two basic head styles—straight-sided and tapered, and two basic shank styles—4-way split shank and hybrid shank, in the disclosed embodiments. As shown in the figures, either style of head may be paired with either style of shank, resulting in four different post designs. The particular post design used for an individual patient can be determined based on the patient's circumstances and the expertise of the dentist.

All of the embodiments of the posts 40/70/90/110 described above include the radiused transition from the primary thread to the secondary thread region for stress reduction and improved post strength. All of the embodiments may also include localized shot peening or other treatments, if appropriate, to improve material properties in certain regions of the post. All of the embodiments also include the notches in the rings of the head, for crown rotation prevention. Furthermore, either the slotted drive head or the internal drive socket head may be implemented in any of the posts 40/70/90/110.

The crown posts 40/70/90/110 may be made of any material with sufficient strength properties and which is suitable for implanting in the human body. For example, the crown posts may be made of a stainless steel, such as SAE 316, or of a titanium alloy. The posts may also be made of a carbon fiber composite material. In addition, the posts may be made of polyethyl ethyl ketone (PEEK), which is a semicrystalline thermoplastic with excellent mechanical and chemical resistance properties. Other materials, not listed here, may also be used for the posts, as long as the material possesses suitable physical properties and can be fabricated in the desired shape.

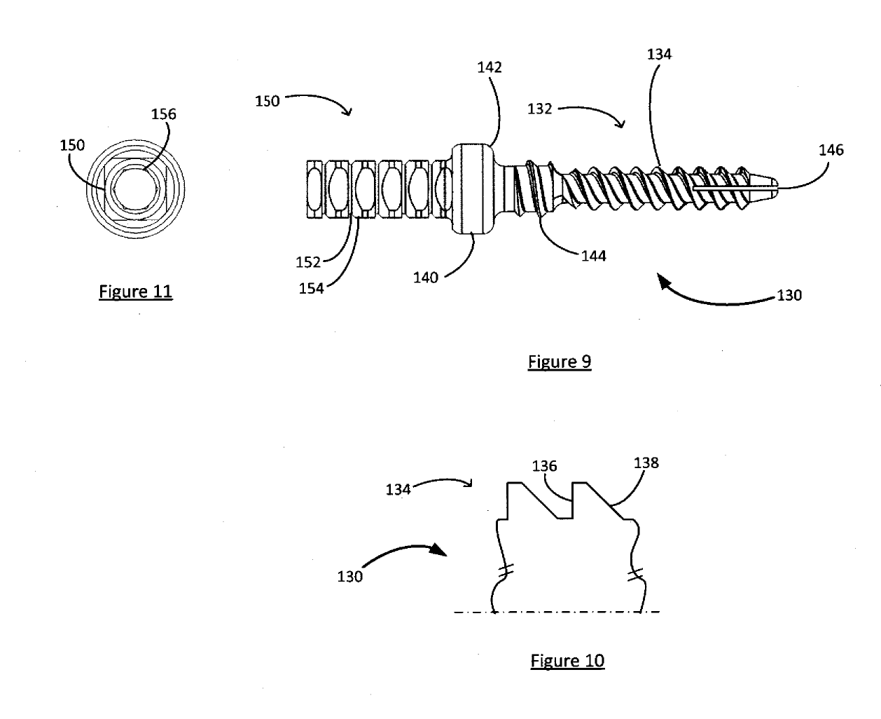

FIG. 9 is a side view illustration of a crown post 130, another embodiment which is similar to the posts 40 and 70 discussed above, with some notable differences. The post 130 includes a shank 132 with primary threads 134. The primary threads 134 in this embodiment are double lead threads; that is, there are two thread “starts”, so that the lead of the threads 134 is two times the pitch. Double lead threads are advantageous for faster insertion of the post 130 than posts with single threads. Double lead primary threads could be used on any of the dental posts discussed previously.

The primary threads 134 on the post 130 are also different in that they have a buttress thread shape. FIG. 10 is a cross-sectional illustration of a buttress thread, as used for the primary thread 134 on the post 130 of FIG. 9. A small portion of the post 130 is shown in FIG. 10, with centerline at the bottom and truncated at the left and right. A buttress thread has an asymmetrical shape, where a load-bearing thread face 136 and an opposite thread face 138 are set at much different angles. The load-bearing thread face 136 is perpendicular to the post axis, or at a slight slant (usually no greater than 7°). The opposite thread face 138 is slanted at approximately 45°. The resulting thread form has the same low friction properties as a square thread but about twice the shear strength due to the long thread base. Thus, the buttress thread type for the primary thread 134 offers a low insertion torque, but provides a very high shear strength and pull-out strength for the post 130. A buttress thread type could also be used on any of the dental posts discussed above.

The post 130 includes a flange 140 similar to those shown on the posts 40 and 70. However, the flange 140 has a different shape than discussed on earlier embodiments. The flange 140 includes a radiused leading edge 142 which serves to reduce radial stress at the location where the flange 140 bears against the tooth/root of the patient. The radiused leading edge 142 along with the flange outer diameter allow the flange 140 to be countersunk in the tooth/root of the patient for further increased stability of the post 130.

Additionally, the post 130 includes a secondary thread 144, which acts as a locking thread to prevent the post 130 from backing out of the root cavity over time. The secondary thread 144 is effective as a locking thread due to its larger diameter than the primary threads 134, and also due to the fact that the secondary thread 144 only penetrates a limited distance into the tooth/root (typically less than two full turns) so that the fit of the secondary thread 144 into the tooth/root remains very tight.

At the right of FIG. 9, at the apical end of the shank 132, a longitudinal slot 146 can be seen. As discussed previously for the post 40, the post 130 includes a 4-way split shank to increase compliance of the shank 132 and reduce root stress and minimize fracture risk during installation. The shank 132 of the post 130 includes another longitudinal slot (not visible in FIG. 9) perpendicular to the slot 146. The two longitudinal slots in the shank 132 may have the same length or may have different lengths.

The post 130 also includes a head or coronal end 150 which features a different concept for preventing rotation in the crown-to-post attachment. FIG. 11 is an end view illustration of the crown post 130 of FIG. 9, where it can be seen that the coronal end 150 has a square cross sectional shape. The square cross section of the coronal end 150 provides extremely high anti-rotation bias of the crown relative to the post. The coronal end 150 also includes grooves 152 interspersed between wider lands 154. The lands 154 have the square shape visible in FIG. 11. As discussed previously, the grooves 152 and lands 154 provide high mechanical grip (pull-off strength) when the crown is bonded to the post 130. The coronal end 150 having the shape features shown in FIGS. 9 and 11 provides tremendous strength in the crown-to-post attachment—both pull-off strength and anti-rotation. The grooves 152 may be circular or square, and the entire coronal end 150 may be formed in any suitable manner—such as machining, heading, casting, molding, etc.

The post 130 is also shown with a hex drive socket 156, visible in FIG. 11. As discussed previously, the post 130 may incorporate screwdriver slots rather than the hex drive socket 156. Similarly, other features of the post 130—including thread features, flange shape, coronal end shape, etc.—may be incorporated in other post designs. For example, the square cross-section of the coronal end 150 of the post 130 may be combined with the hybrid shank (unthreaded tip) of the posts 70 and 90. Generally speaking, any of the coronal end shapes and features may be combined with either of the shank types (unthreaded tip or 4-way split shank), to provide an optimal combination of crown-to-post bond strength and anti-root-fracture protection.

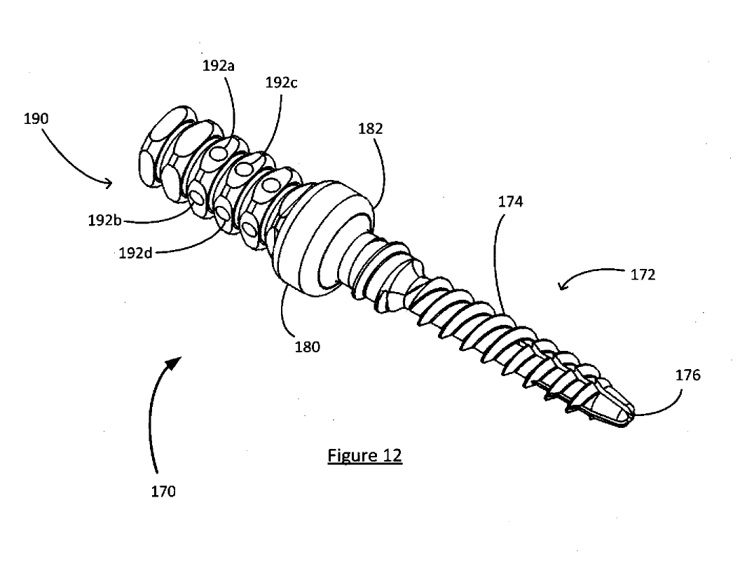

FIG. 12 is an isometric view illustration of a crown post 170, which is similar to the post 130 discussed above, with yet another feature. The post 170 includes a shank 172 with primary threads 174, and longitudinal slots 176 providing a 4-way split shank, as discussed above for the post 130. The post 170 also includes a flange 180 with a radiused leading edge 182, as also included on the post 130.

The post 170 has a coronal section 190 which includes a new feature. Holes 192 are formed in the coronal section 190 to permit cement to enter and provide better fixation of the crown to the post 170. In a preferred embodiment, the holes 192 are through-holes which pass completely through the coronal section 190 from one side to the other. The holes 192 are preferably cylindrical, drilled or otherwise formed perpendicular to the centerline of the post 170. Further, the holes 192 are preferably arranged in perpendicular cross-axis pairs which intersect along the centerline of the post 170. Thus, each of the holes 192 has a corresponding hole perpendicular to and intersecting it, so that cement can pass freely within the resulting “plus-sign” shaped cavity. For example, the holes 192a and 192b are perpendicular to each other and intersect along the centerline of the post 170. Likewise for the holes 192c and 192d, which intersect with each other and are located at a different longitudinal position than the holes 192a and 192b. As shown in FIG. 12, there are three pairs of the holes 192, each at a different longitudinal position on the coronal section 190 of the post 170. More or fewer than three pairs could be used in other embodiments.

The holes 192 facilitate the spreading of cement to many locations inside the crown to provide better fixation of the crown to the post 170. Instead of just hoping for cement to evenly distribute along the crown-to-post interface surface, the dentist can be assured that cement will be present in each of the holes 192 and provide firm bonding of the post 170 to the crown at each of these locations. In addition, cement which solidifies inside the holes 192 after installation of the crown provides significant additional mechanical grip, further strengthening the crown-to-post bond. The dentist may pre-fill the holes 192 with cement, after the post 170 has been installed in the root canal and just before fitting the crown in place.

The holes 192 may also not pass all the way through the coronal section 190, but instead may be shorter in depth, such as a depth which is about ¼ of the thickness of the coronal section 190 of the post 170. Holes 192 which are not through-holes would not allow migration of liquid cement between the hole passages (because the hole passages would not intersect), but would still provide repositories for holding liquid cement and offer the benefit of improved strength of the crown-to-post bond as discussed above.

The dental crown post designs described above include numerous features which are advantageous over prior art designs—including features which minimize the likelihood of root fracture during post installation, features which increase the strength of the post itself, and features which increase the pull-out strength of the post in the root and the strength of the crown-to-post attachment. The structural features of the different shank designs and different head designs can be combined into a variety of posts which give dentists a range of options for successfully and securely installing posts and crowns which meets the needs of their patients.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A dental crown post comprising:
a coronal section including a plurality of alternating rings and grooves configured for bonding a crown thereto, where the rings and grooves are oriented coaxially to a longitudinal axis of the post and the post has a coronal end at a free end of the coronal section;
an apical section opposite the coronal section, where the apical section includes a generally cylindrical shank having a primary thread external to the shank, the post has an apical end at a free end of the shank opposite the coronal end of the post, and the shank includes an anti-root-fracture feature extending from the apical end partway along a length of the shank; and
a mid-section positioned between the coronal section and the apical section, where the mid-section includes a cylindrical shape having an external secondary thread and a diameter greater than a diameter of the shank, and where a transition from the diameter of the shank to the diameter of the mid-section has a radiused fillet shape.

2. The post according to claim 1 wherein the anti-root-fracture feature is two longitudinal slots in the shank which are arranged perpendicularly to each other through a cross section of the shank such that the shank is split into four segments of equal cross-sectional area.

3. The post according to claim 2 wherein the two longitudinal slots in the shank extend for different distances along the length of the shank.

4. The post according to claim 1 wherein the coronal section includes a flange proximal the mid-section of the post, where the flange has a diameter greater than any of the rings in the coronal section, and the flange includes a radius or bevel on a leading edge of its outer diameter in order to minimize stress at a tooth contact location.

5. The post according to claim 4 wherein the coronal section has a profile which tapers from widest at the flange to narrowest at the coronal end, with each successive ring being smaller in diameter.

6. The post according to claim 1 wherein the coronal section includes a band proximal the mid-section of the post, where the band has a diameter equal to a diameter of the rings in the coronal section.

7. The post according to claim 1 further comprising a plurality of notches formed into an outer diameter of the rings, where the notches are aligned axially at two or more circumferential positions around the rings.

8. The post according to claim 1 further comprising a plurality of holes for cement holding formed in the rings of the coronal section, said holes having a cylindrical shape with an axis perpendicular to the longitudinal axis of the post.

9. The post according to claim 1 further comprising one or more slots in the coronal end for receiving a tool to torsionally drive the post into position.

10. The post according to claim 1 further comprising an internal drive socket in the coronal end for receiving a tool to torsionally drive the post into position.

11. The post according to claim 1 wherein a portion of the mid-section is treated for locally improved material properties and surface quality.

12. The post according to claim 1 wherein the post is made of stainless steel or titanium.

13. The post according to claim 1 wherein the post is made of a carbon fiber composite.

14. The post according to claim 1 wherein the post is made of polyethyl ethyl ketone.

15. A dental crown post comprising:
a coronal section including a plurality of alternating rings and grooves configured for bonding a crown thereto, where the rings and grooves are oriented coaxially to a longitudinal axis of the post, and the post has a coronal end at a free end of the coronal section;
an apical section opposite the coronal section, where the apical section includes a generally cylindrical shank having a threaded portion and an unthreaded tip, the threaded portion has a primary thread external to the shank, and the post has an apical end at a free end of the unthreaded tip; and
a mid-section positioned between the coronal section and the apical section, where the mid-section includes a cylindrical shape having an external secondary thread and a diameter greater than a diameter of the shank, and where a transition from the diameter of the shank to the diameter of the mid-section has a radiused fillet shape.

16. The post according to claim 15 wherein the threaded portion and the unthreaded tip of the apical section each occupy between 40% and 60% of a length of the shank.

17. The post according to claim 15 wherein the unthreaded tip includes a plurality of circumferential grooves along its length.

18. A dental crown post comprising:
a coronal section including a plurality of alternating lands and grooves configured for bonding a crown thereto, where the lands and grooves are oriented coaxially to a longitudinal axis of the post, and the post has a coronal end at a free end of the coronal section;
an apical section opposite the coronal section, where the apical section includes a generally cylindrical shank having a primary thread external to the shank, the post has an apical end at a free end of the shank opposite the coronal end of the post, and the shank includes two longitudinal slots extending from the apical end partway along a length of the shank; and
a mid-section positioned between the coronal section and the apical section, where the mid-section includes a cylindrical flange proximal the coronal section and a secondary thread proximal the primary thread, and where the secondary thread has a diameter greater than a diameter of the shank, and the cylindrical flange has a diameter greater than the diameter of the secondary thread.

19. The post according to claim 18 wherein the lands of the coronal section have a generally square cross-sectional shape about the longitudinal axis of the post.

20. The post according to claim 18 further comprising a plurality of holes for cement holding formed in the lands of the coronal section, said holes having a cylindrical shape with an axis perpendicular to the longitudinal axis of the post.

21. The post according to claim 20 wherein the holes pass entirely through the coronal section and are arranged in perpendicularly intersecting pairs at one or more locations along the longitudinal axis of the post.

22. The post according to claim 18 wherein the primary thread is a double lead thread having two thread starts providing a lead which is two times a thread pitch.

23. The post according to claim 18 wherein the primary thread has a buttress thread shape with a load-bearing face oriented toward the coronal end of the post.
